(19) United States
(12) Patent Application Publication
(10) Pub. No.: US 2009/0000858 A1
(43) Pub. Date: Jan. 1, 2009

(54) STEERING DEVICE WITH VARIABLE STEERING RATIO MECHANISM

(75) Inventors: Isao Ikegaya, Hamana-gun (JP); Tadao Itou, Toyohashi-shi (JP)

Correspondence Address: FOLEY AND LARDNER LLP;SUITE 500, 3000 K STREET NW, WASHINGTON, DC, 20007, US

(73) Assignee: FUJI KIKO CO., LTD.

(21) Appl. No.: 12/180,949

(22) Filed: Jul. 28, 2008

(30) Foreign Application Priority Data
May 25, 2007 (JP) 2007-138704

(51) Int. Cl. B62D 5/04

(52) U.S. Cl. 180/444

(57) ABSTRACT

A first reduction ratio established between first internal teeth of an input gear and first external teeth of a first planetary gear of an annular planetary gear unit is set different from a second reduction ratio established between a second internal teeth of an output gear and second external teeth of a second planetary gear of the annular planetary gear unit. A rotation cam unit is installed in a circular opening of the annular planetary gear unit to cause, upon rotation thereof, the first and second planetary gears to make an eccentric rotation relative to a common axis of the first and second internal teeth thereby to induce a circumferential movement of a first meshed portion between the first external teeth and the first internal teeth and a second meshed portion between the second external teeth and the second internal teeth. The rotation cam unit is actuated by an electric motor.

### BACKGROUND OF THE INVENTION

1. Field of the Invention

The present invention relates in general to steering devices with a variable steering ratio mechanism and more particularly to the steering devices of a type that provides an intermediate shaft, which is connected to a steering wheel, with the variable steering ratio mechanism.

2. Description of the Related Art

Hitherto, various types of steering devices have been proposed and put into practical use in the field of wheeled motor vehicles. One of them is of a type equipped with a steering ratio mechanism that is able to vary a ratio of a steering wheel angle relative to a steered road wheel angle in accordance with a vehicle speed. One of the steering devices of such type is disclosed in Japanese Laid-open Patent Application (Tokkai) 2000-211541.

In the steering device of the Laid-open patent application, a variable steering ratio mechanism is mounted to an intermediate shaft that connects a steering shaft equipped with a steering wheel to a pinion shaft of a steering mechanism. In the device, the steering shaft (viz., input side) and the pinion shaft (viz., output side) are respectively equipped with internal gears which are different in number of teeth. A cylindrical flex-spline, which is flexible, having teeth on an outer surface thereof is engaged or meshed with each of the two internal gears at two portions that are circumferentially spaced by 180 degrees. An oval cam is installed in the flex-spline and driven by an electric motor. By turning the oval cam by the electric motor, the meshed positions between the flex-spline and each of the internal gears are shifted in a circumferential direction. That is, when the oval cam is turned by the electric motor, the meshed portions appearing due to pressing of the external teeth of the flex-spline against the teeth of each internal gear are moved in the circumferential direction, so that for every one turn of the oval cam, the pinion shaft is forced to turn relative to the steering shaft in a direction opposite to that of the oval cam by a degree corresponding to a difference between the number of teeth of one of the internal gears and that of the other internal gear. Thus, by varying the number of revolutions of the oval cam, the difference in rotation between the pinion shaft and the steering shaft can be varied. That is, by changing the direction of rotation and the rotation speed of the electric motor, the rotation speed of the pinion shaft can be increased or decreased relative to the rotation speed of the steering shaft.

### SUMMARY OF THE INVENTION

However, due to its inherent construction, the flex-spline needs a quite skilled technique for production, which brings up the cost of manufacturing of the flex-spline and thus that of the steering device. Furthermore, due to the thinner cylindrical construction, the flex-spline has failed to exhibit a satisfied durability and strength against the torque transmission. That is, if, under cruising of a motor vehicle, an excessive external force is applied to steered road wheels in a direction to drive the same in a reversed direction, deformation of the flex-spline tends to occur which causes a teeth skip (viz., disengagement of mutual teeth) of the flex-spline relative to the pinion shaft.

Accordingly, an object of the present invention is to provide a steering device with a variable steering ratio mechanism, which is free of the above-mentioned drawbacks.

According to the present invention, there is provided a steering device which comprises an input gear adapted to be connected to a steering wheel, the input gear having first internal teeth; an output gear adapted to be connected to a pinion shaft of a steering mechanism, the output gear having second internal teeth; an annular planetary gear unit including a first planetary gear having first external teeth engageable with the first internal teeth and a second planetary gear having second external teeth engageable with the second internal teeth, the number of the first external teeth being smaller than that of the first internal teeth, and the number of the second external teeth being smaller than that of the second internal teeth, the annular planetary gear unit having therein a circular opening which is concentric with both the first and second planetary gears; a rotation cam unit installed in the circular opening of the annular planetary gear unit, the rotation cam unit, upon rotation thereof, causing the first and second planetary gears of the annular planetary gear unit to make an eccentric rotation relative to a common axis of the first and second internal teeth thereby to induce a circumferential movement of a first meshed portion where the first external teeth and the first internal teeth are meshed and a second meshed portion where the second external teeth and the second internal teeth are meshed; and an electric motor for driving the rotation cam unit through an output shaft, wherein a first reduction ratio established between the first internal teeth and the first external teeth is different from a second reduction ratio established between the second internal teeth and the second external teeth.

That is, when the rotation cam unit is turned upon energization of the electric motor, the annular planetary gear unit is turned in such a manner that the first and second planetary gears turn about respective eccentric centers. Accordingly, the first meshed portion and the second meshed portion are forced to assume the same position in a circumferential direction and the two meshed portions are moved in the circumferential direction keeping the same relative positioning therebetween. Under this movement, the first and second planetary gears (viz., the planetary gear unit) are forced to rotate in a direction opposite to the turning direction of the rotation cam unit by a degree corresponding to a difference in number of the teeth between the first planetary gear (or the second planetary gear) and the input gear (or the output gear). Since the first reduction ratio is set different from the second reduction ratio, the second internal teeth are forced to turn relative to the first internal teeth by a degree that corresponds to a difference in revolution degree between the first planetary gear and the second planetary gear because of the united structure of the first and second planetary gears. That is, by turning the rotation cam unit in normal/reverse direction and varying the rotation amount (or speed) of the rotation cam unit by the electric motor, the rotation speed of the output gear is varied relative to the input gear.

Because of the above-mentioned construction of the steering device, in the present invention, there is no need of employing an element such as the cylindrical flex-spline shown in the above-mentioned publication 2000-211541. Thus, the steering device of the present invention is free of the drawbacks inevitably possessed by the flex-spline. Furthermore, because of simplicity of construction, reduction of cost is achieved by the present invention.

### BRIEF DESCRIPTION OF THE DRAWINGS

Other objects and advantages of the present invention will become apparent from the following description when taken in conjunction with the accompanying drawings, in which:

FIG. 1 is a sectional view of a steering device with a variable steering ratio mechanism, which is a first embodiment of the present invention;

FIG. 2 is a partially cut exploded view of essential elements of the steering device of the first embodiment;

FIG. 3 is a partially cut exploded view of the essential elements which are partially assembled;

FIG. 4A is a sectional view taken along the line A-A of FIG. 1;

FIG. 4B is a sectional view taken along the line B-B of FIG. 1;

FIG. 5 is a view similar to FIG. 1, but showing a second embodiment of the present invention; and

FIG. 6 is a view similar to FIG. 2, but showing the second embodiment of the present invention.

### DETAILED DESCRIPTION OF THE EMBODIMENTS

In the following, two embodiments of the present invention will be described in detail with reference to the accompanying drawings.

For ease of understanding, various directional terms, such as, right, left, upper, lower, rightward and the like are used in the following description. However, such terms are to be understood with respect to only a drawing or drawings on which a corresponding element or portion is shown.

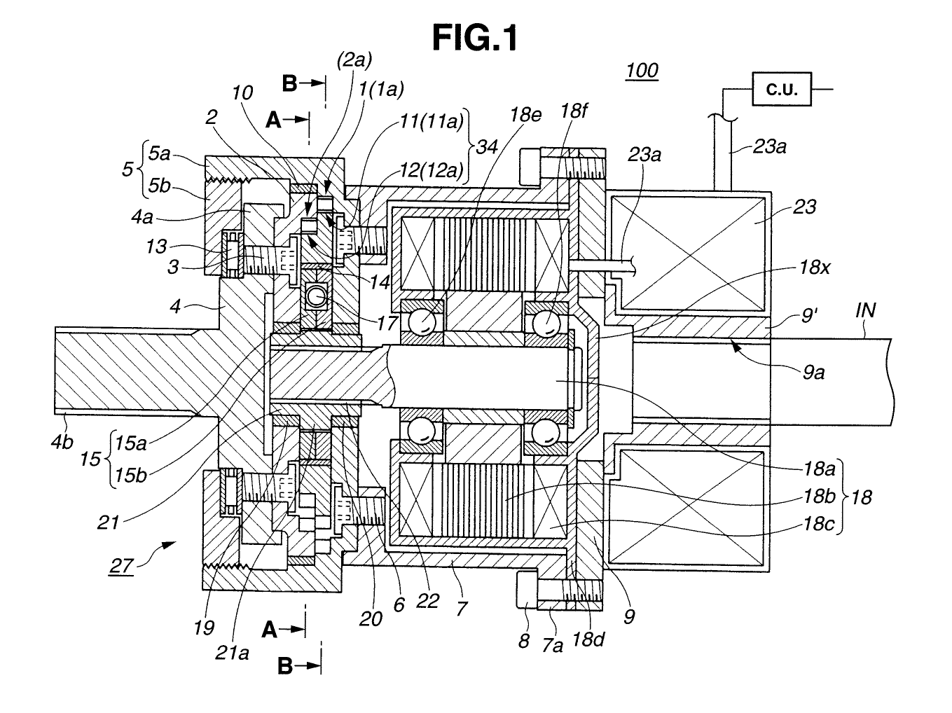

Referring to FIGS. 1 to 4B of the drawings, there is shown a steering device 100 with a variable steering ratio mechanism, which is a first embodiment of the present invention.

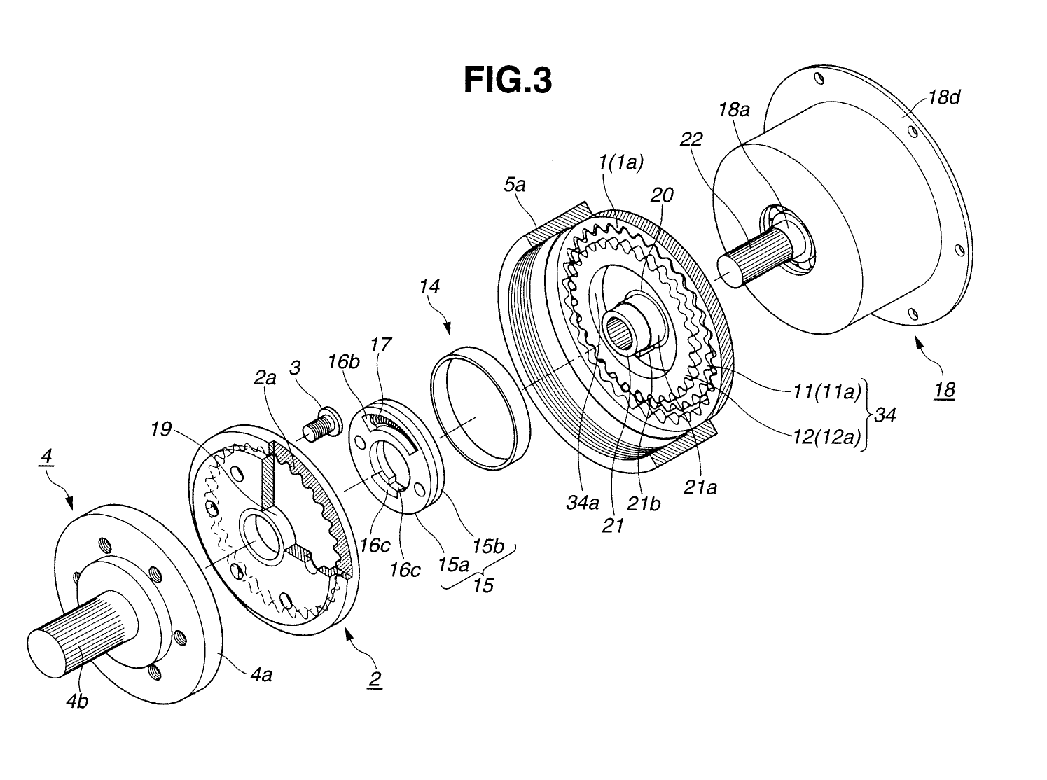

As is well shown in FIGS. 1 to 3, particularly FIG. 3, the steering device 100 comprises an input gear 1 and an output gear 2 which are arranged to face to each other.

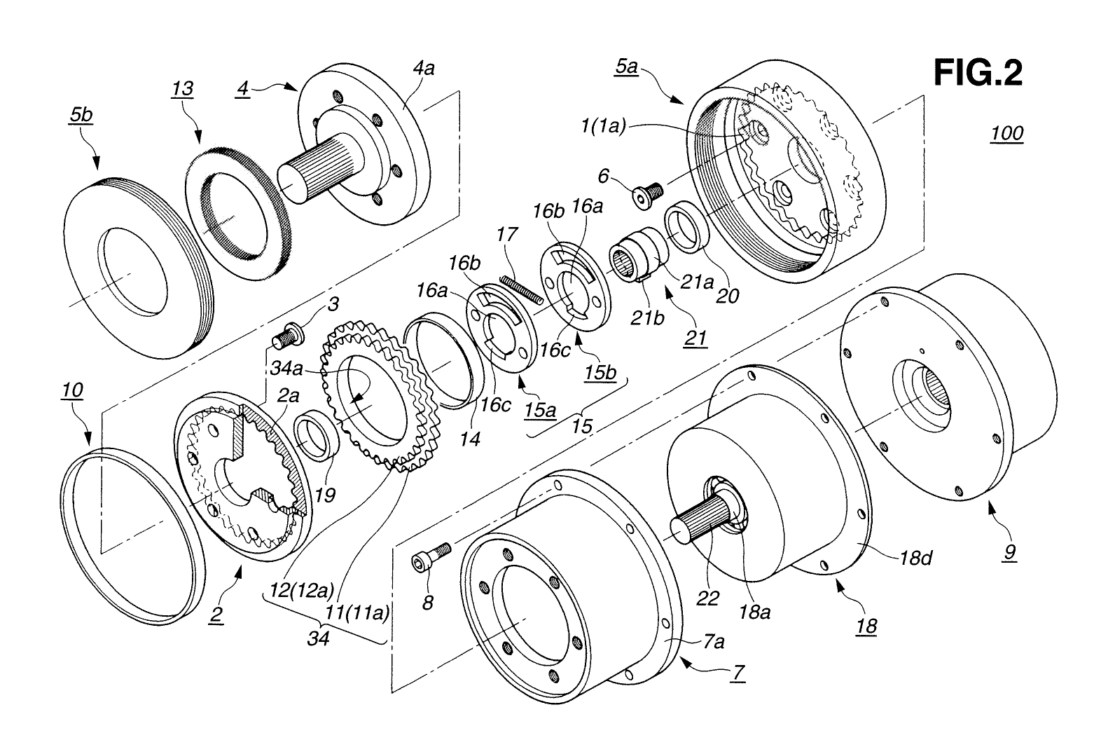

As is seen from FIG. 2 (and FIG. 3), the input gear 1 is integrally provided by a bottomed cylindrical holder body 5a. That is, as shown, the input gear 1 is constituted by internal teeth 1a formed on a cylindrical inner wall of the body 5a. The bottom of the holder body 5a is connected to an annular outer surface of a cylindrical motor holder 7 through six bolts 6 each having a hexagonal driver catch opening.

As is seen from FIGS. 2 and 3, to an annular flange 7a formed on a right end of the holder body 5a, there is connected an electric motor 18 through six bolts 8 in such a manner that a major cylindrical body of the motor 18 is neatly received in the holder body 5a. Furthermore, to an annular flange 18d formed on a right end wall 18x of a case of the motor 18, there is connected a circular head input member 9 through the above-mentioned bolts 8.

As is seen from FIG. 1, to the circular head input member 9, there is connected a left end of an intermediate shaft “IN” through a spline connection 9a provided therebetween. That is, the circular head input member 9 has a tubular portion 9′ whose cylindrical wall is splined for establishing the spline connection 9a with the intermediate shaft “IN”. Although not shown in the drawing, the intermediate shaft “IN” has a leading or right end to which a steering wheel (not shown) is connected to rotate therewith.

As is seen from FIG. 1 and understood from FIG. 2, the output gear 2 comprises internal teeth 2a and is rotatably received in the cylindrical holder body 5a with an annular plain bearing 10 operatively received therebetween. That is, the annular plain bearing 10 is put between an annular space defined between the perimeter of the output gear 2 and an inner cylindrical surface of the holder body 5a.

As is seen from FIGS. 2 and 3, the output gear 2 is connected through six bolts 3 to an annular flange 4a integrally formed on a circular head output member 4, so that a unit including the output gear 2 and circular head output member 4 is provided. Each bolt 3 has a hexagonal driver catch opening.

Although not shown in the drawings, the circular head output member 4 is connected at a splined shaft portion 4b thereof to a pinion shaft (not shown) of a steering mechanism from which tie rods extend to steered road wheels (not shown).

As is seen from FIGS. 1, 2 and 3, in order to stably and rotatably hold the unit in the cylindrical holder body 5a, an annular lid 5b is detachably connected or screwed to a mouth portion of the holder body 5a to constitute a holder 5. As shown in FIG. 1, an annular thrust bearing 13 is neatly received in an annular step (no numeral) defined by the annular lid 5b. Due to provision of such thrust bearing 13 and the above-mentioned annular plain bearing 10, rotation of the unit (viz., the unit including the output gear 2 and circular head output member 4) in the holder body 5a is smoothly made.

As is seen from FIGS. 1 and 2, between the input gear 1 and output gear 2, there is arranged an annular planetary gear unit 34 that comprises a first planetary gear 11 that has external teeth 11a engageable with the internal teeth 1a of the input gear 1 and a second planetary gear 12 that has external teeth 12a engageable with the internal teeth 2a of the output gear 2. The first and second planetary gears 11 and 12 are integrally formed to constitute a so-called one piece unit.

As may be seen from FIG. 2, the number of the internal teeth 1a of the input gear 1 is thirty two (viz., 32) and the number of the external teeth 11a of the first planetary gear 11 is thirty (viz., 30). While, the number of the internal teeth 2a of the output gear 2 is twenty five (viz., 25) and the number of the external teeth 12a of the second planetary gear 12 is twenty three (viz., 23).

As shown in FIG. 2, the integral first and second planetary gears 11 and 12 are formed at their center portions with a common circular opening 34a. Within the circular opening 34a, there is received through an annular plain bearing 14 a rotation cam unit 15 that comprises a pair of rotation cams 15a and 15b.

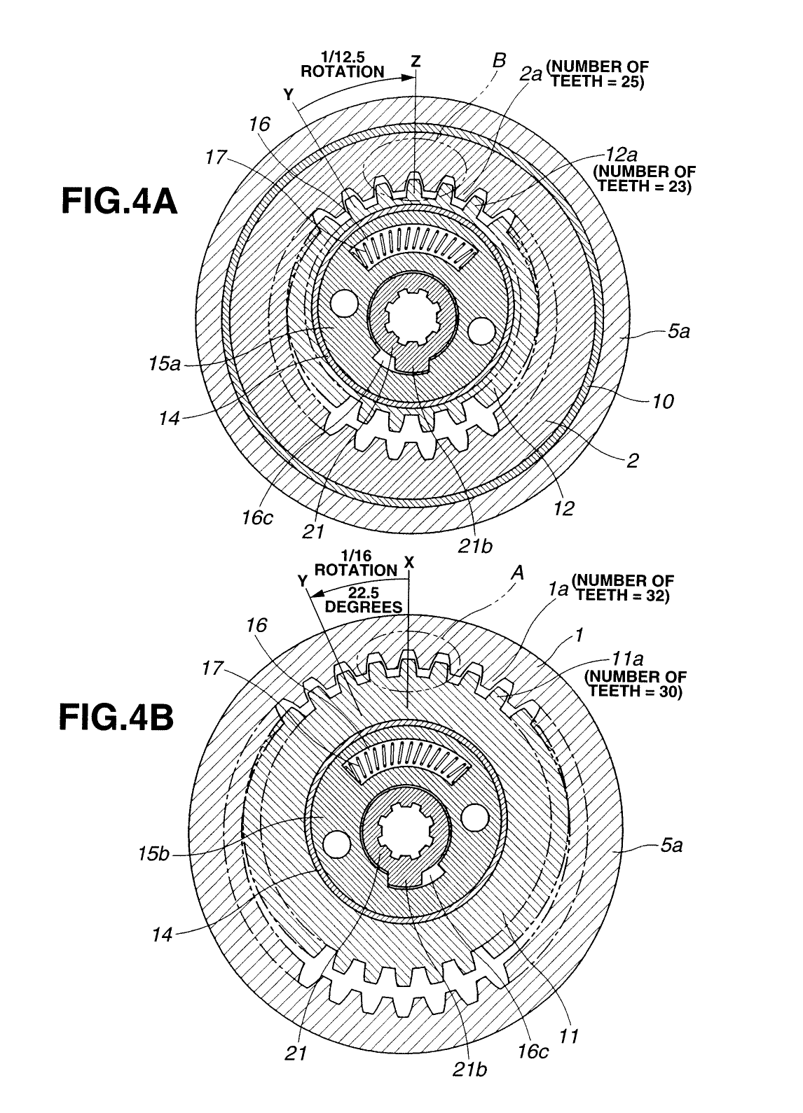

As is seen from FIGS. 3, 4A and 4B, the rotation cam unit 15 functions to permit a circumferential movement of a first meshed portion “A” (see FIG. 4B) where the external teeth 11a of the first planetary gear 11 are engaged with the internal teeth 1a of the input gear 1 and a second meshed portion “B” (see FIG. 4A) where the external teeth 12a of the second planetary gear 12 are engaged with the internal teeth 2a of the output gear 2.

As is seen from FIG. 3, the two rotation cams 15a and 15b have respective circular eccentric openings 16a and 16a of which eccentric degrees relative to centers of the cams 15a and 15b are the same. That is, the circular eccentric opening 16a of each rotation cam 15a or 15b is provided at an eccentric portion of the rotation cam 15a or 15b. Each rotation cam 15a or 15b is formed with an arcuate slot 16b each extending in a circumferential direction. Upon assembly, the actuate slots 16b and 16b of the two rotation cams 15a and 15b are merged to constitute a shape variable arcuate slot in which a single elongate spring 17 is compressed with longitudinal ends thereof abutting against opposed ends of the shape variable slot.

For rotation of the cam unit 15, the electric motor 18 is used, which is installed in the motor holder 7 that integrally rotates with the input gear 1.

As is seen from FIGS. 1 and 2, the electric motor 18 comprises the annular flange 18d that is tightly put between the annular flange 7a of the motor holder 7 and the circular head input member 9, an output shaft 18a that is rotatably held by a case structure (no numeral) through two bearings 18e and 18f, a rotor 18b that is mounted on the output shaft 18a to rotate therewith, and coils 18c that are circularly arranged around the output shaft 16a at front and rear sides of the rotor 18b.

As is seen from the drawings, a left end portion of the output shaft 18a is formed with a splined portion 22. The splined portion 22 is operatively engaged with a splined inner wall of a hollow drive shaft 21 that is rotatably held by both the output gear 2 and the cylindrical holder body 5a through respective annular plain bearings 19 and 20. That is, the output shaft 18a of the motor 18 and the hollow drive shaft 21 are connected through a spline connection.

As is best seen from FIG. 2, the hollow drive shaft 21 is formed with a diametrically enlarged support portion 21a that is received in the eccentric openings 16a and 16a of the above-mentioned rotation cams 15a and 15b.

As is seen from FIGS. 2 and 3, the support portion 21a has a raised key portion 21b that is loosely received in key slots 16c and 16c that are formed in the rotation cams 15a and 15b in a manner to merge with the eccentric openings 16a and 16a. Thus, the rotation cam unit 15 and the hollow drive shaft 21 are able to rotate together.

As is seen from FIGS. 4A and 4B, the circumferential length of each key slot 16c is greater than the circumferential width of the raised key portion 21b.

With such loosed connection between the key slot 16c and the raised key portion 21b, the following advantageous function is achieved.

That is, due to function of the single elongate spring 17, the rotation cams 15a and 15b are biased to turn in opposite directions to increase an eccentric degree thereby pressing the annular planetary gear unit 34 (viz., first and second planetary gears 11 and 12) against the internal teeth 1a of the input gear 1 and the internal teeth 2a of the output gear 2. Thus, a backlash of the first and second meshed portions “A” and “B” (see FIGS. 4B and 4A) is suppressed. Upon rotation of the hollow drive shaft 21, the raised key portion 21b is pressed against one of opposed ends of the key slot 16c of selected one of the rotation cams 15a and 15b, which causes an aligned or matched arrangement of the two rotation cams 15a and 15b and thus reduces the eccentric degree inducing the backlash of the first and second meshed portions “A” and “B”. Due to generation of such backlash, the movement of the meshed portions is smoothly carried out.

As is described hereinabove, as to the portion that constitutes the first meshed portion “A”, the number of internal teeth 1a of the input gear 1 is thirty-two (viz., 32) and that of the external teeth 11a of the first planetary gear 11 is thirty (viz., 30), and as to the second meshed portion “B”, the number of the internal teeth 2a of the output gear 2 is twenty five (viz., 25) and that of the external teeth 12a of the second planetary gear 12 is twenty three (viz., 23). That is, the total number of the teeth that constitute the second meshed portion “B” is less than that of the teeth that constitute the first meshed portion “A”. Accordingly, a first reduction ratio “G1” between the internal to teeth 1a of the input gear 1 and the external teeth 11a of the first planetary gear 11 is “32/(32−30)=16” and a second reduction ratio “G2” between the internal teeth 2a of the output gear 2 and the external teeth 12a of the second planetary gear 12 is “25/(25−23)=12.5”. That is, the first and second reduction ratios “G1 and G2” are set to have different values. In the illustrated embodiment, the first reduction ratio “G1” is larger than the second reduction ratio “G2”.

As will be seen from FIG. 1, the electric motor 18 integrally rotates with the holder 5 that turns in response to turning of the intermediate shaft “IN”, that is, in response to turning of the steering wheel (not shown).

As is seen from FIG. 1, the circular head input member 9 is provided, around the tubular portion 9′ thereof, with an annular cable holding case 23 in which a spiral flat cable 23a is operatively wound. That is, the cable holding case 23 generally comprises an inner case half that rotates with the circular head input member 9 and an outer case half that is able to rotate relative to the inner case half. One end of the spiral flat cable 23a is connected to the coils 18c of the motor 18 and the other end of the spiral flat cable 23a is connected to a control unit “C.U.”. In order to allow one or two free turns of the electric motor 18 together with the circular head input member 9, a certain slack is provided by the spiral flat cable 23a.

In the following, operation of the steering device 100 with the variable steering ratio mechanism of the first embodiment will be described with the aid of the drawings, especially FIG. 1.

When, under cruising of an associated motor vehicle, the steering wheel is turned in one direction, the circular head input member 9 is turned in the same direction through the intermediate shaft “IN”, and thus, the motor holder 7 fixed to the circular head input member 9 and the holder 5 are rotated in the same direction like a single unit.

If, under the turning of the steering wheel, the motor 18 is not energized, the holder 5 and the annular planetary gear unit 34 are integrally revolved through the first meshed portion “A” and at the same time the annular planetary gear unit 34 and the output gear 2 are integrally revolved through the second meshed portion “B”, so that the circular head output member 4 and the circular head input member 9 are integrally revolved like a single unit.

While, if, under the turning of the steering wheel, the motor 18 is energized, the output shaft 18a of the motor 18 is turned in a given direction. Upon this, the hollow drive shaft 21, which is meshed with the output shaft 18a through the spline connection, is turned in the same direction inducing a rotation of the rotation cam unit 15 in the same direction.

Since the rotation cam unit 15 takes an eccentric position relative to the rotation axis of the hollow drive shaft 21, the rotation of the cam unit 15 thus induced induces a turning of the annular planetary gear unit 34 keeping the first planetary gear 11 and the second planetary gear 12 meshed with the internal teeth 1a of the input gear 1 and the internal teeth 2a of the output gear 2 respectively.

Let us assume that, as is seen from FIG. 4B, the first meshed portion “A” where the external teeth 11a of the first planetary gear 11 are meshed with the internal teeth 1a of the input gear 1, and as is seen from FIG. 4A, the second meshed portion “B” where the external teeth 12a of the second planetary gear 12 are meshed with the internal teeth 2a of the output gear 2 take the same position in a circumferential direction.

Now, when, under the above-mentioned condition, the first and second meshed portions “A” and “B” make one revolution around the axis of the hollow drive shaft 21 due to rotation of the cam unit 15, the first planetary gear 11 and the second planetary gear 12 are forced to rotate in a direction opposite to that of the cam unit 15 by a degree (or angle of rotation) that corresponds to a difference between the number of teeth of the first planetary gear 11 and that of teeth of the input gear 1 or a difference between the number of teeth of the second planetary gear 12 and that of teeth of the output gear 2. In other words, the input gear 1 is forced to turn relative to the first planetary gear 11 in the same direction as the cam unit 15 by a degree (or angle of rotation) that corresponds to the difference between the number of teeth of the input gear 1 and that of the first planetary gear 11, and at the same time, the output gear 2 is forced to turn relative to the second planetary gear 12 in the same direction as the cam unit 15 by a degree or angle or rotation that corresponds to the difference between the number of teeth of the output gear 2 and that of the second planetary gear 12.

That is, in the steering device 100 of the first embodiment, the ratio (or reduction ratio) “G1” between the internal teeth 1a of the input gear 1 and the external teeth 11a of the first planetary gear 11 is set to “16”, and the ratio (or reduction ratio) “G2” between the internal teeth 2a of the output gear 2 and the external teeth 12a of the second planetary gear 12 is set to “12.5”. Accordingly, when the rotation cam unit 15 is turned once in one direction, the input gear 1 is forced to make 1/16 turn in the same direction and at the same time, the output gear 2 is forced to make 1/12.5 turn in the same direction. The difference in rotation angle between the input gear 1 and the output gear 2 brings about a degree of rotation (viz., rotation angle) of the output gear 2 relative to the input gear 1.

The above explanation will be much easily understood from the following description when taken in conjunction with FIGS. 4A and 4B.

When, in FIG. 4B, the rotation cam unit 15 (viz., 15a+15b) is turned once in a clockwise direction, the external teeth 11a of the first planetary gear 11 taking an angular position “X” relative to the input gear 1 are moved or turned in a counterclockwise direction to another angular position “Y” that is away from the angular position “X” by a degree (or angle of rotation) that corresponds to the difference “2” (viz., 32−30=2) between the number “32” of the internal teeth 1a of the input gear 1 and the number “30” of the external teeth 11a of the first planetary gear 11.

Upon this turning, as is seen from FIG. 4A, the external teeth 12a of the second planetary gear 12 take an angular position “Y” that corresponds to the above-mentioned position “Y” of the external teeth 11a of the first planetary gear 11.

In view of the angular position “Y” (see FIG. 4A) of the external teeth 12a of the second planetary gear 12, it can be estimated that before the single turning of the rotation cam unit 15, the external teeth 12a would take an angular position “Z” that is away from the position “Y” in a clockwise direction by a degree (or angle of rotation) that corresponds to the difference “2” (viz., 25−23=2) between the number “25” of the internal teeth 2a of the output gear 2 and the number “23” of the external teeth 12a of the second planetary gear 12. Accordingly, the angular position “Z” of the output gear 2 relative to the angular position “X” of the input gear 1 means an angular difference between the input and output gears 1 and 2.

When, in the steering device 100 of the first embodiment, the rotation cam unit 15 turns once relative to the input gear 1 in a clockwise direction, the output gear 2 is forced to make about 1/57 turn (viz., 1/12.5−1/16÷1/57) in the same direction relative to the input gear 1.

Accordingly, the number of revolutions of the output gear 2 is increased as compared with that of the input gear 1. In other words, the output gear 2 turns faster than the input gear 1.

By increasing or decreasing the rotation speed of the to electric motor 18, the increase in revolutions of the output gear 2 is varied. When the rotation direction of the electric motor 18 is reversed, the rotation speed of the output gear 2 reduces, and by increasing or decreasing the rotation speed of the motor 18, the decrease in revolutions of the output gear 2 is varied.

When the electric motor 18 is arranged to drive gears that have less number of teeth, the rotation direction of the input gear 1 is reversed relative to a direction in which the rotation cam unit 15 turns.

When, under cruising of an associated motor vehicle, the output gear 2 is applied with a certain force from the steered road wheels through the output member 4, the output gear 2 (see FIG. 4A) is forced to induce a rotation of the annular planetary gear unit 34 (see FIGS. 2 and 3) in a reversed direction. However, due to the inertia of the rotating output shaft 18a of the electric motor 18, the nature of the reduction ratio established between the input and output members “IN” and 4 and the nature of the cam angle of the rotation cam unit 15, such reversed rotation of the annular planetary gear unit 34 is suppressed. Furthermore, because of the high structural rigidity, the annular planetary gear unit 34 is suppressed from making gear slip. That is, the two rotation cams 15a and 15b are suppressed from being applied with a reversed torque, and thus the electric motor 18 is prevented from being driven by the external torque. This means that there is no need of providing a so-called lock device that is able to lock the output shaft 18a of the motor 18 at the time when the motor 18 fails to rotate due to shut down of the engine and/or break down of an electric circuit.

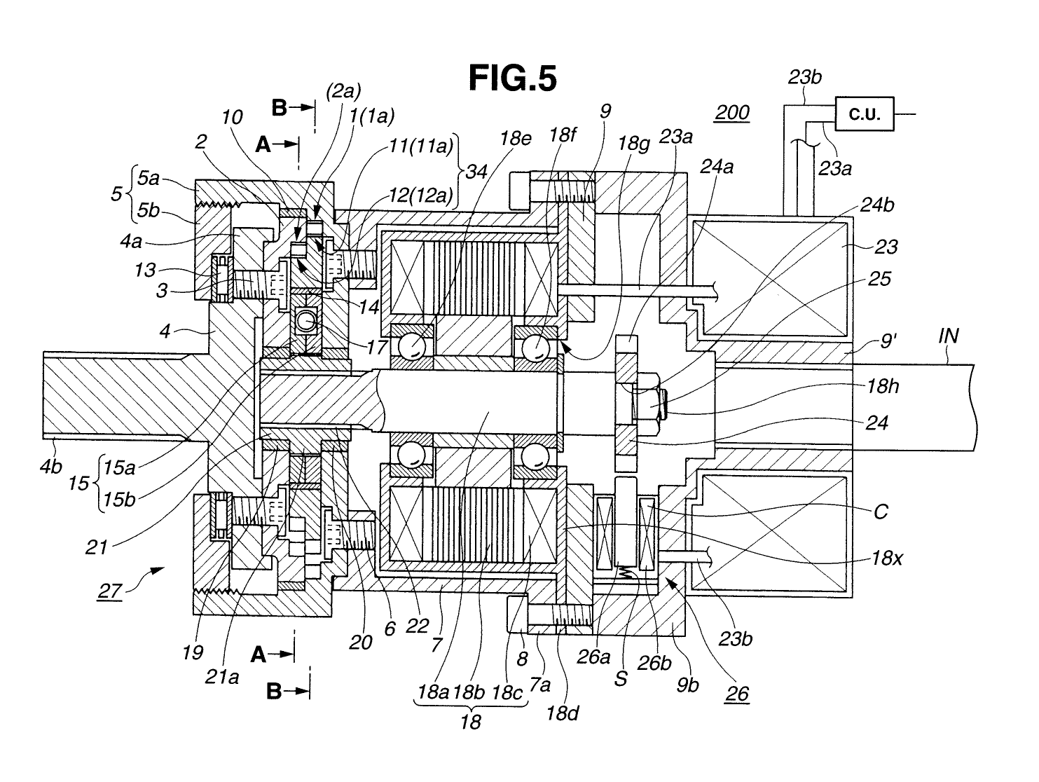

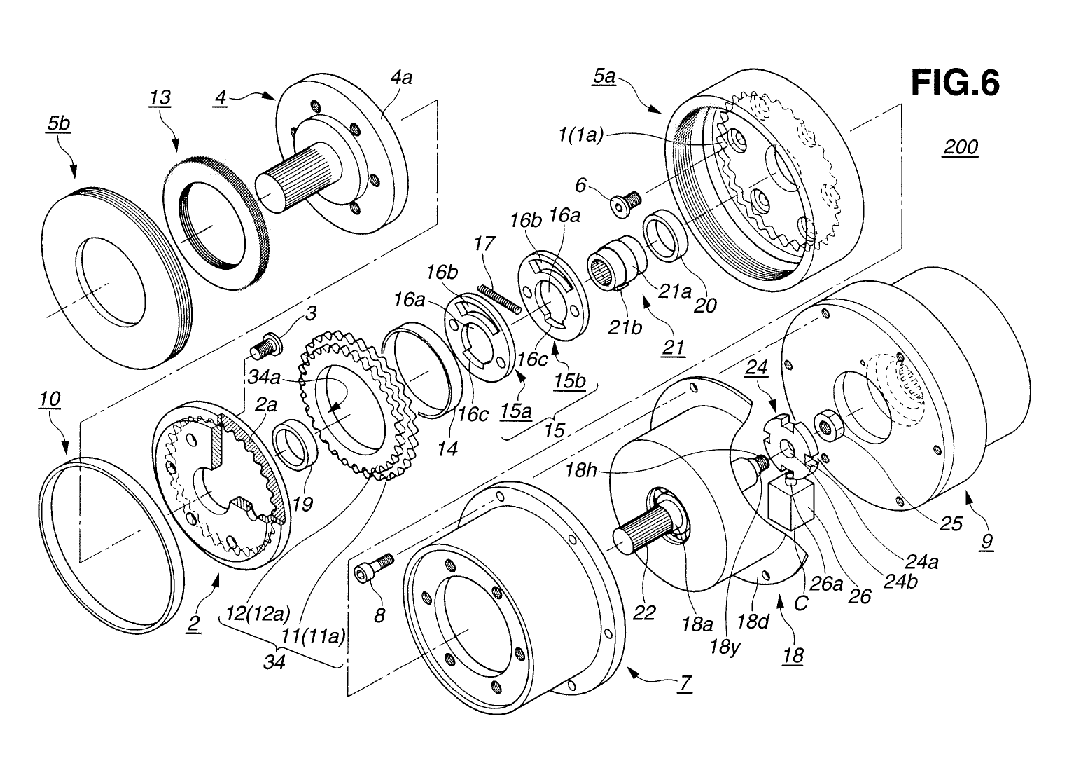

Referring to FIGS. 5 and 6, there is shown a steering device 200 with a variable steering ratio mechanism, which is a second embodiment of the present invention.

In the steering device 200 of the second embodiment, the above-mentioned lock device is provided for assuredly locking or stopping the rotation of the output shaft 18a of the motor 18 when the motor 18 fails to rotate.

Since the steering device 200 of this second embodiment is similar in construction to the above-mentioned steering device 100 of the first embodiment, only parts and portions that are different from those of the steering device 100 of the first embodiment will be described in detail in the following.

In this second embodiment 200, there is provided a lock device that can lock the output shaft 18a of the electric motor 18 as the need arises.

As is seen from the drawings, the right end wall 18x of the case of the motor 18 is formed with a circular opening 18g through which a right end portion of the output shaft 18a of the motor 18 extends rightward.

As is best seen from FIG. 6, to the right end portion of the output shaft 18a, there is tightly connected a generally circular lock plate 24 by means of a nut 25. For this tight connection, the circular lock plate 24 is formed at a center thereof with an oval opening 24b, the right end portion of the output shaft 18a has an oval cross-section part 18y that is mated with the oval opening 24b and the right end portion has a threaded leading end 18h that is tightly engaged with the nut 25. Thus, output shaft 18a of the electric motor 18 and the circular lock plate 24 constitute an integrated unit. If desired, the tight connection between the output shaft 18a and the circular lock plate 24 may be made by means of a spline connection.

The circular lock plate 24 is formed at a peripheral portion thereof with equally spaced four cuts 24a.

As is seen from FIG. 5, for providing a space for the circular lock plate 24, a cylindrical body part 9b is integrally provided by the tubular portion 9′ of the circular head input member 9.

As is seen from FIGS. 5 and 6, below the circular lock plate 24, there is arranged a lock pin device 26 that is able to lock the circular lock plate 24 as the need arises.

The lock pin device 26 comprises a lock pin 26a axially movably received in a case “C”, a spring “S” (see FIG. 5) installed in the case “C” to bias the lock pin 26a in a direction to project toward the circular lock plate 24 and an electric coil 26b constructed to attract or draw the lock pin 26a against the biasing force of the spring “S” when energized. Accordingly, when the electric coil 26b is kept energized, the lock pin 26a is forced to assume its OFF position as is seen from FIG. 5. The electric coil 26b is connected to the control unit “CU” through another spiral flat cable 23b that is received in the annular cable holding case 23.

In the following, operation of the steering device 200 with the variable steering ration mechanism of the second embodiment will be described with the aid of the drawings, especially FIG. 5. Since the operation of the steering device 200 of the second embodiment is similar to that of the steering device 100 of the first embodiment because of the similarity in construction therebetween, only operation that is different from the operation of the steering device 100 of the first embodiment will be described in the following with the aid of FIGS. 5 and 6.

When the motor 18 operates normally, the electric coil 26b of the lock pin device 26 is kept energized. Under this condition, the lock pin 26a is retracted by the energized electric coil 26b, and thus, the lock plate 24 fixed to the output shaft 18a of the motor 18 is released from the lock pin 26a as is seen from FIG. 5. Accordingly, under this condition, the steering device 200 of this second embodiment operates in the same manner as the above-mentioned steering device 100 of the first embodiment.

However, when the electric motor 18 fails to operate due to shut down of the engine and/or break down of an electric circuit, energization of the electric coil 26b of the lock pin device 26 stops. Upon this, the lock pin 26a is pushed into one of the cuts to 24a of the lock plate 24 due to the force of the spring “S”, and thus, the output shaft 18a of the motor 18 is locked. Under this condition, the revolution of the input gear 1 is directly transmitted to the output gear 2 through the annular planetary gear unit 34. Accordingly, the input gear 1 and the output gear 2 is rotate in the same direction like a single unit without speed change therebetween.

As will be easily understood from FIG. 6, even if the lock pin 26a fails to align with one of the cuts 24a, slight rotation of the output shaft 18a of the motor 18, which would be caused by the force applied to the output member 4 from the wheeled road wheels, brings about the engagement of the lock pin 26a with the cut 24a.

If desired, the following modification may be applied to the above-mentioned steering devices 100 and 200 of the first and second embodiments.

That is, in the above mentioned steering devices 100 and 200, the first reduction ratio “G1” (=16) established between the internal teeth 1a of the input gear 1 and the external teeth 11a of the first planetary gear 11 is set larger than the second reduction gear “G2” (=12.5) established between the internal teeth 2a of the output gear 2 and the external teeth 12a of the second planetary gear 12. However, if desired, the ratio “G1” may be smaller than the ratio “G2”.

The entire contents of Japanese Patent Application 2007-138704 filed May 25, 2007 are incorporated herein by reference.

Although the invention has been described above with reference to the embodiments of the invention, the invention is not limited to such embodiments as described above. Various modifications and variations of such embodiments may be carried out by those skilled in the art, in light of the above description.

What is claimed is:

1. A steering device comprising:
an input gear adapted to be connected to a steering wheel, the input gear having first internal teeth;
an output gear adapted to be connected to a pinion shaft of a steering mechanism, the output gear having second internal teeth;
an annular planetary gear unit including a first planetary gear having first external teeth engageable with the first internal teeth and a second planetary gear having second external teeth engageable with the second internal teeth, the number of the first external teeth being smaller than that of the first internal teeth, and the number of the second external teeth being smaller than that of the second internal teeth, the annular planetary gear unit having therein a circular opening which is concentric with both the first and second planetary gears;
a rotation cam unit installed in the circular opening of the annular planetary gear unit, the rotation cam unit, upon rotation thereof, causing the first and second planetary gears of the annular planetary gear unit to make an eccentric rotation relative to a common axis of the first and second internal teeth thereby to induce a circumferential movement of a first meshed portion where the first external teeth and the first internal teeth are meshed and a second meshed portion where the second external teeth and the second internal teeth are meshed; and
an electric motor for driving the rotation cam unit through an output shaft,
wherein a first reduction ratio established between the first internal teeth and the first external teeth is different from a second reduction ratio established between the second internal teeth and the second external teeth.

2. A steering device as claimed in claim 1, in which the number of the first external teeth is smaller than that of the first internal teeth by one or two, and in which the number of the second external teeth is smaller than that of the second internal teeth by one or two.

3. A steering device as claimed in claim 2, in which the first reduction ratio is larger than the second reduction ratio.

4. A steering device as claimed in claim 3, in which the first reduction ratio is 16 and the second reduction ratio is 12.5.

5. A steering device as claimed in claim 2, in which the first reduction ratio is smaller than the second reduction ratio.

6. A steering device as claimed in claim 1, in which the electric motor is mounted to either one of the input and output gears.

7. A steering device as claimed in claim 1, in which the rotation cam unit comprises:
two rotation cams having respective circular eccentric openings and respective arcuate slots, the two rotation cams being coupled together in such a manner that the respective circular openings are merged and the respective arcuate slots are merged while permitting a certain relative rotation therebetween;
a single elongate spring installed in the merged arcuate slots to bias the two rotation cams to turn in opposite directions thereby increasing an eccentric degree and thus pressing the annular planetary gear unit against the first internal teeth and the second internal teeth; and
a hollow drive shaft received in the merged circular eccentric openings, the hollow drive shaft being loosely latched with the two rotation cams with a function of a loose latch mechanism so that rotation of the hollow drive shaft induces a rotation of the two rotation cams in the same direction, the hollow drive shaft being coupled with an output shaft of the electric motor.

8. A steering device as claimed in claim 7, in which the loose latch mechanism comprises:
a raised key portion provided by the hollow drive shaft; and
key slots formed in the rotation cams in a manner to be merged with the circular eccentric openings, the key slots loosely receiving therein the raised key portion.

9. A steering device as claimed in claim 8, in which an annular plain bearing is received in an annular space that is defined between a unit of the rotation cams and an inner cylindrical wall of the circular opening of the annular planetary gear unit.

10. A steering device as claimed in claim 1, further comprising a lock device that is able to lock the output shaft of the electric motor.

11. A steering device as claimed in claim 10, in which the lock device comprises:
a circular lock plate secured to the output shaft of the electric motor, the circular lock plate having a plurality of cuts at a peripheral portion thereof; and
a lock pin device having a lock pin that is able to project into one of the cuts for locking the output shaft.

12. A steering device as claimed in claim 11, in which the lock pin device comprises:
a case;
the lock pin axially movably received in the case;
a spring for biasing the lock pin in a direction to project toward the circular lock plate; and
an electric coil for attracting or drawing the lock pin against the biasing force of the spring when electrically energized.
